(19) United States
(12) Patent Application Publication
(10) Pub. No.: US 2002/0138319 A1
(43) Pub. Date: Sep. 26, 2002

(54) Order assembly production system and method

(76) Inventors: Kazumasa Kaburagi, Chiba-shi (JP); Yukio Kunieda, Akiruno-shi (JP); Masanori Ikaga, Funabashi-shi (JP); Yoshio Anzai, Tokyo (JP); Tsuyoshi Kiyota, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/072,986

(22) Filed: Feb. 12, 2002

(30) Foreign Application Priority Data
Feb. 13, 2001 (JP) 2001-036027

(51) Int. Cl. G06F 17/60

(52) U.S. Cl. 705/7

(57) ABSTRACT

An order assembly production method comprising preparing manufacturing schedules of several months on the basis of a demand forecast on a predetermined period basis that is shorter than a monthly basis, reviewing the manufacturing schedules every predetermined period, and issuing the reviewed manufacturing schedules of several months, issuing a procurement instruction of parts on the basis of the reviewed manufacturing schedules, issuing a manufacture instruction when an order is received from a customer, and assembling the parts in accordance with the manufacture instruction.

### CROSS-REFERENCE TO RELATED APPLICATIONS

This application is based upon and claims the benefit of priority from the prior Japanese Patent Application No. 2001-036027, filed Feb. 13, 2001, the entire contents of which are incorporated herein by reference.

### BACKGROUND OF THE INVENTION

1. Field of the Invention

The present invention relates in general to a production system and method for product assembly, and more particularly to a production system and method having a short lead time which does not cause excess production or lost sales opportunities.

2. Description of the Related Art

In general, the production flow from a number of discrete product components to a finished product incorporating those components generally comprises the following steps: (1) component design; (2) product design; (3) component procurement; (4) component stocking in a manufacturer's component warehouse; (5) component processing in a manufacturing facility (“factory”); (6) product stocking in the manufacturing facility; (7) final product assembly in the manufacturing facility; (8) final product stocking in a product warehouse; (9) shipment of final products; (10) final product stocking in an intermediate warehouse; and (11) delivery/installation of the final product.

Conventional production systems can be roughly classified into the following two systems.

An engineering-to-order (or made-to-order production system), wherein one or both of steps 1 and 2 discussed above (i.e., component design and/or product design) are initiated after an order is received, is generically called an “individual order production system.”

On the other hand, a made-to-stock production system (or sale-to-stock production system), wherein one or both of steps 7 and 9 discussed above (i.e., final product assembly and/or factory shipment) are performed before receiving the order, is generically called a “prospect production system.” In the prospect production system, the final products are held or stored (“stocked”) in a product warehouse or shipped to and stocked in an intermediate warehouse (steps 8 and 10) until an order for the final product is received.

There are benefits and drawbacks to both the individual order production system and the prospect production system. Because there is at present a rapid pace of technical innovation, the value of the product or component may quickly fall. Additionally, due to market competition, product pricing competition may be very keen. Moreover, in order to meet the needs and desires of today's demanding consumers for new and improved product features, a product's components and specifications will constantly be changing.

Under these circumstances, one benefit of the order production system is that because production of products is not performed based on a forecast, but only based on actual orders for the product, excess production leading to increased inventories of unordered products is avoided. However, one drawback of the individual order production system is that there is a longer lead time before shipment of the product after the product is ordered. Thus, in such systems, loss of sales opportunities may result because the product is not readily available.

In contrast, one benefit of the prospect production system is that the lead time from order placement to shipment of the product is shortened because the products are already assembled and stocked. However, one drawback of the prospect production system is that the quantity of products assembled and stocked is based on a demand forecast of a considerably future time (usually, one or more months ahead), and, thus, the accuracy of the demand forecast may be questionable. If the forecast proves wrong (e.g., the demand is less than the forecast demand), the product inventory may increase because of excess production. This increase in product inventory may lead to outdated product stock, collapse of the product price, lower evaluation of a component of the product, deterioration of cash flow, increased depreciation expenses, and the like. Moreover, when demand is larger than the forecast, a shortage occurs, and there may be lost sales opportunities.

Thus, it can be seen from the foregoing that to minimize the possibility of excess production (and thus the possibility of having an outdated product inventory) due to the actual demand for a product being lower than the demand forecast, the lead time is necessarily lengthened. Moreover, it can also be seen from the foregoing that to minimize the loss of sales opportunities, various products have to be supplied in a short lead time. In the two conventional production systems described above, minimization of both excess production and lead time from order placement to shipment of the product cannot simultaneously be achieved.

Additionally, as an example of the conventional individual order production system, “Manufacturing System and Assembly System of Computer System in Order Manufacturing Environment” is described in Japanese Patent Publication (KOKAI) No. 11-285936 (published on Oct. 19, 1988). The system is generally called an order assembly production system. According to the order assembly production system, the final assembly is made from the parts or the intermediate product in response to order entry. Accordingly, a lead time is short. Moreover, it is possible to prevent the inventory from being increased or the sales opportunity from being missed due to the fluctuation of demand.

Since the order assembly production system has a monthly demand forecast, (3) the component procurement or (5) the component processing is made so that the number of products to be manufactured (the number of products to be shipped) every month can be secured. In response to an inquiry about delivery time from a customer, only delivery time per month can be returned. Consequently, it is impossible to answer the customer whether the product can be delivered at the beginning or the end of a month. Particularly, the delivery time is very important for a customer who purchases a product with short life cycle. Accordingly, when correct delivery time cannot be shown to the customer, it results in missing of the sales opportunity. The fact is a large problem for makers. Further, the actual final assembly is made after order entry. When there is no order entry at the beginning and the middle of a month and order entries are collected at the end of the month, the target number of products per month may not be accomplished and the delivery time may not be kept. Accordingly, the fact may result in a factor in that the maker loses the customer's confidence.

As mentioned above, according to the conventional order assembly production system having the advantages of both of the individual order production system and the prospect production system, only the delivery time per month is known. When the demand is remarkably increased, there is a problem in that the delivery time cannot be kept.

### BRIEF SUMMARY OF THE INVENTION

An embodiment of the present invention pertains to an order assembly production system and method which properly adjusts to the fluctuation of demand and whereby substantially correct delivery time can be shown to a customer.

Another embodiment of the present invention pertains to an order assembly production system and method which adjusts a remarkable increase in demand and whereby a product is delivered according to delivery time given to a customer.

According to an embodiment of the present invention, there is provided an order assembly production method comprising:

preparing manufacturing schedules of several months on the basis of a demand forecast on a predetermined period basis that is shorter than a monthly basis, reviewing the manufacturing schedules every predetermined period, and issuing the reviewed manufacturing schedules of several months;

issuing a procurement instruction of parts on the basis of the reviewed manufacturing schedules;

issuing a manufacture instruction when an order is received from a customer; and

assembling the parts in accordance with the manufacture instruction.

According to an embodiment of the present invention, there is provided another order assembly production method comprising:

preparing manufacturing schedules of several months on the basis of a demand forecast on a predetermined period basis that is shorter than a monthly basis, reviewing the manufacturing schedules every predetermined period while excepting a manufacturing schedule of a predetermined period from a target to be reviewed, and issuing the reviewed manufacturing schedules of several months;

calculating the number of order-acceptable products for each predetermined period excepted from the reviewed target and the scheduled number of products to be manufactured for each subsequent predetermined period on the basis of the reviewed manufacturing schedules; and

making a response about delivery time to a customer with reference to the calculated number of order-acceptable products.

According to an embodiment of the present invention, there is provided an order assembly production system comprising:

a first system which prepares manufacturing schedules of several months on the basis of a demand forecast on a predetermined period basis that is shorter than a monthly basis and reviews the manufacturing schedules every predetermined period; and

a second system which issues a procurement instruction of parts on the basis of the reviewed manufacturing schedules and, when receiving an assembly instruction from the first system in accordance with an order from a customer, instructs to start to assemble the parts.

According to an embodiment of the present invention, there is provided another order assembly production system comprising:

a first system which prepares manufacturing schedules of several months on the basis of a demand forecast on a predetermined period basis that is shorter than a monthly basis and reviews the manufacturing schedules every predetermined period while excepting a manufacturing schedule of a predetermined period from a target to be reviewed; and

a second system which issues a procurement instruction of parts on the basis of the reviewed manufacturing schedules and makes a response about the number of order-acceptable products for each predetermined period excepted from the reviewed target and the scheduled number of products to be manufactured for each subsequent predetermined period on the basis of the reviewed manufacturing schedules to the first system,

wherein the first system makes a response about delivery time to a customer with reference to the number of order-acceptable products.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a diagram showing the outline of an order assembly production system according to an embodiment of the present invention;

FIG. 2 is a diagram showing the operation of a business department and the operation of a manufacturing department for each day according to the embodiment;

FIG. 3 shows a manufacturing schedule of a certain week (W) according to the embodiment;

FIG. 4 shows a manufacturing schedule of the next week (W+1) according to the embodiment;

FIG. 5 is a diagram showing an outline of production management according to the embodiment;

FIG. 6 is a diagram showing the relation between a daily manufacturing schedule and a manufacture possible limit;

FIGS. 7A and 7B are a block diagram showing an outline of the order assembly production system according to the embodiment, and FIG. 7C shows the manner in which FIGS. 7A and 7B are combined;

FIG. 8 is a flowchart schematically showing the operation of the order assembly production system in FIGS. 7A and 7B; and

FIG. 9 is a diagram showing an outline of a vender managed inventory (VMI) system for use in the order assembly production system in FIGS. 7A and 7B.

### DETAILED DESCRIPTION OF THE INVENTION

An embodiment of an order assembly production system according to the present invention will now be described hereinbelow with reference to the drawings. According to the embodiment, the manufacture of a personal computer, in which its life cycle is short (for example, three months) and the cycle has a large fluctuation in demand, will be described as an example.

To easily understand, the present embodiment will now be described with compared with a related art.

In a conventional prospect production system, the following data is transmitted or received between a head office (business department) and a factory (manufacturing department).

In consideration of the sales results of sales routes and products (models), budgets, and measures of the company, the head office informs the factory of monthly manufacturing schedules (the target number of products to be shipped) of several months on the basis of monthly demand forecasts and budgets. When it is assumed that the schedule cannot be accomplished, the factory can consult with the head office to adjust the schedules. When the monthly manufacturing schedule is determined, the factory makes a daily manufacturing schedule in order to accomplish the target number of products, manufactures the products in accordance with the schedule, and stores the products. When an order is received from the head office, the stored products are shipped out.

On the other hand, in the conventional order assembly production system, the following data is transmitted and received between the head office and the factory.

The head office informs the factory of monthly manufacturing schedules of several months and the factory makes the daily manufacturing schedule. Although the procedure so far is similar to the above, the manufacture is not made. Part order, component processing (intermediate product manufacture), or intermediate product order are made. Parts or intermediate products are stored as an inventory. The intermediate product indicates a PC board having an IC or the like thereon or a hard disk drive. When an order from the head office is received, the stored parts are processed or the intermediate product is assembled to manufacture an end product and the product is shipped out.

Each of the above-mentioned systems is based on the monthly manufacturing schedule. Accordingly, in response to an inquiry about delivery time, only delivery time on a monthly basis can be shown. Moreover, in the order assembly production system, the assembly of the intermediate product is started after the order is actually received. Accordingly, in case where there is no order entry at the beginning and the middle of a month and the order entries are collected at the end of the month, the target number of products manufactured per month cannot be accomplished, so that the delivery time may not be kept.

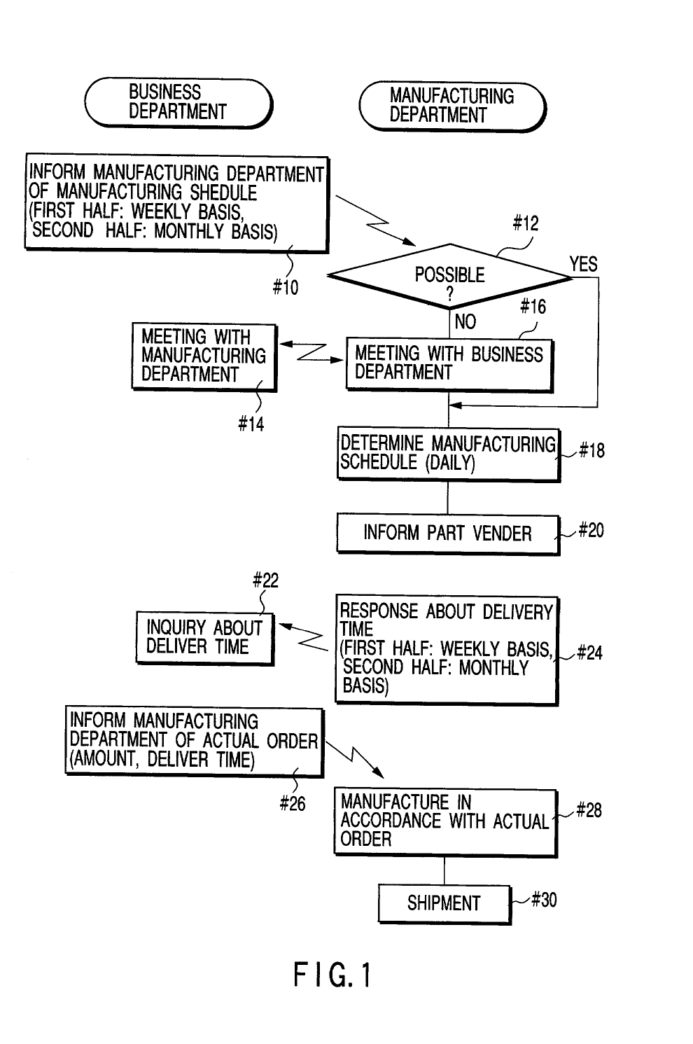

In the order assembly production system according to the present embodiment, data is transmitted or received between the business department (head office) and the manufacturing department (factory) as shown in FIG. 1.

The head office makes manufacturing schedules of several months (e.g., six months) and informs the factory of the schedules. The manufacturing schedules are made on a weekly basis. The head office informs the factory of the weekly manufacturing schedules of the former months (in this case, three months). As to the schedules of the latter months, the schedules are made on a monthly basis and are then shown (step #10). A month and a week, each of which serves as a schedule unit, denote calendar month and calendar week. The manufacturing schedule is formed every sales route and every product model. Not only the weekly manufacturing schedules of the first half months but also those of the whole months can be shown as weekly manufacturing schedules. It is not necessary to submit the monthly manufacturing schedules of the second-half three months. Furthermore, as to the number of months for the weekly manufacturing schedules, two months or four months can be set. Instead of the weekly basis, a schedule on another basis, namely, five-day or three-day basis can be formed. The specific numerical value can be arbitrarily set in accordance with the product life cycle, the demand forecast, and the production system in the factory.

As shown in steps #12, #14, and #16, the factory determines whether the schedules can be accomplished. If NO, the factory can consult with the business department to adjust the schedules. The adjustment is actually controlled in the next and subsequent weekly manufacturing schedules.

The manufacturing schedules are reviewed every week. That is, the head office obtains the demand forecast every week to again make the manufacturing schedules in accordance with the obtained information and information fed back from the factory in step #16. The review is made in short time as mentioned above, so that a difference between supply and demand can be compensated. Consequently, an influence caused by the imbalance between supply and demand can be reduced.

When the manufacturing schedules are determined, the factory makes a daily manufacturing schedule in order to accomplish the target number of products (for each week) (step #18) and then makes preparations for a manufacturing line in accordance with the daily manufacturing schedule (step #20). The preparations include ordering of parts and intermediate products to a part vender, processing of the parts (manufacturing the intermediate products), and arrangement of line operators.

As mentioned above, according to the present embodiment, the manufacturing department makes preparations for the manufacturing line on the basis of the weekly manufacturing schedule submitted by the business department. Accordingly, in response to the inquiry about the delivery time from the business department, the manufacturing department can make a response about the weekly delivery time for a period (intermediate three months) during which the preparations are made (steps #22 and #24). As the response about the delivery time, available information regarding the manufacturing line for each sales route, each week, and each model can be provided. On the basis of the information, it is recommendable to select an available model in response to the inquiry from the customer. Consequently, too much order entries, in which the delivery time cannot be kept, are prevented.

As mentioned above, the business department makes the weekly manufacturing schedules of three months and the monthly manufacturing schedules of the fourth to the sixth months on the basis of the demand forecast, reviews the manufacturing schedules every week, and informs the factory of the reviewed schedules. In the review, the manufacturing schedules of two weeks are fixed, so that they cannot be changed. The factory makes the daily manufacturing schedule in accordance with the manufacturing schedules, orders the parts in accordance with the daily schedule, and holds the part inventory. The products according to the manufacturing schedules of two weeks, which are not reviewed, are surely manufactured. In other words, the number of products manufactured is the number of order-acceptable products. When receiving an actual order (delivery time and the number of products) from a customer, the business department informs the factory of the order contents, and the factory starts to manufacture the products (assemble the intermediate products) in response to the information. As mentioned above, since the business department and the factory follow the weekly manufacturing schedules, the delivery time on a weekly basis can be shown to the customer, so that the precision of the response about delivery time on a weekly basis is higher than that about the conventional response about delivery time on a monthly basis.

Hitherto, since the manufacturing schedule is formed on a monthly basis, only the delivery time on a monthly basis can be derived. Accordingly, whether the delivery is made at the beginning or the end of the month cannot be determined. According to the present embodiment, however, the weekly manufacturing schedule is arranged between the business department and the manufacturing department, so that the customer can be notified of the product delivery time with precision within a week. Moreover, since the manufacturing schedule is formed every model and every sales route, the precision of the response about the delivery time is raised.

When the business department receives the actual order (actual order including the number of products and the delivery time), the manufacture is started and the products are shipped out by the delivery time (steps #26, #28, and #30).

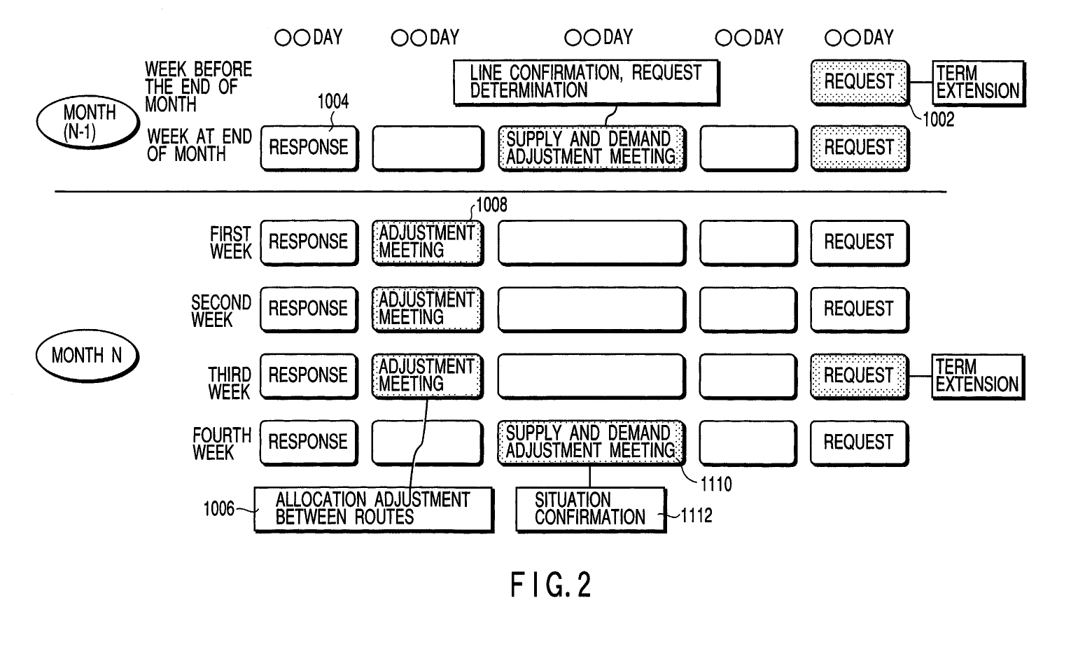

Subsequently, the manufacturing schedules will now be described in detail with reference to FIGS. 2, 3, and 4.

FIG. 2 is a diagram showing daily operating steps for each day and each week. It is assumed that the manufacturing department operates from Monday to Friday. The business department informs the manufacturing department of the target number of products to be manufactured (request 1002) every predetermined day. The demand is forecasted every model and every sales route to form the target number of products to be manufactured. A month N (the present month) to a month (N+2) have the weekly target number of products and a month (N+3) to the end month have the monthly target number of products. The manufacturing department answers whether the schedules can be accomplished to the business department every predetermined day of the next week. Specifically, the manufacturing department answers the number of manufacture-possible products in the factory (for each week and each model) to the business department.

After that, the business department has an adjustment meeting 1008 every predetermined day to review the manufacturing schedules in accordance with the relation between the request and the response 1004 (the fluctuation of supply and demand forecast) and increase or decrease the target number of products for each sales route and that for each model. In accordance with the increase or decrease, the number of products requested for each predetermined day is also increased or decreased. The monthly target number of products to be manufactured may also be varied in some cases. When the number of products, which can be shipped out, is equal to or less than the target number, the products which can be shipped out are allocated among the sales routes (1006). In other words, since all of the requests cannot be accepted, it is determined how many products are shipped out to which sales routes. A difference between the number of requests and the number of responses is managed, so that the excess or deficiency of products can be managed. In a week in which the number of responses is larger than the number of requests, a response limit is displayed as a “part remaining limit” (parts are remained).

The business department does not have the adjustment meeting 1008 in the last week every month. The business department has a supply and demand adjustment meeting 1110 every predetermined day to confirm the situations of the requests and the responses (1112), determine the future line, and review the manufacturing schedules. The supply and demand adjustment meeting 1110 also functions to confirm the situation changed by the weekly manufacturing schedules reviewed by the supply and demand adjustment meeting 1110 of the preceding month. When the actual situation of sales, e.g., “since the products are not sold, they are remained” or “since the products are sold, they are insufficient” is grasped, it is possible to more immediately generate an alarm. Grasping the actual production situation results in correct response about the delivery time. When the “part remaining limit” is managed, it is possible to easily grasp which part and how many parts are remained/will be remained, so that a risk alarm can be immediately generated.

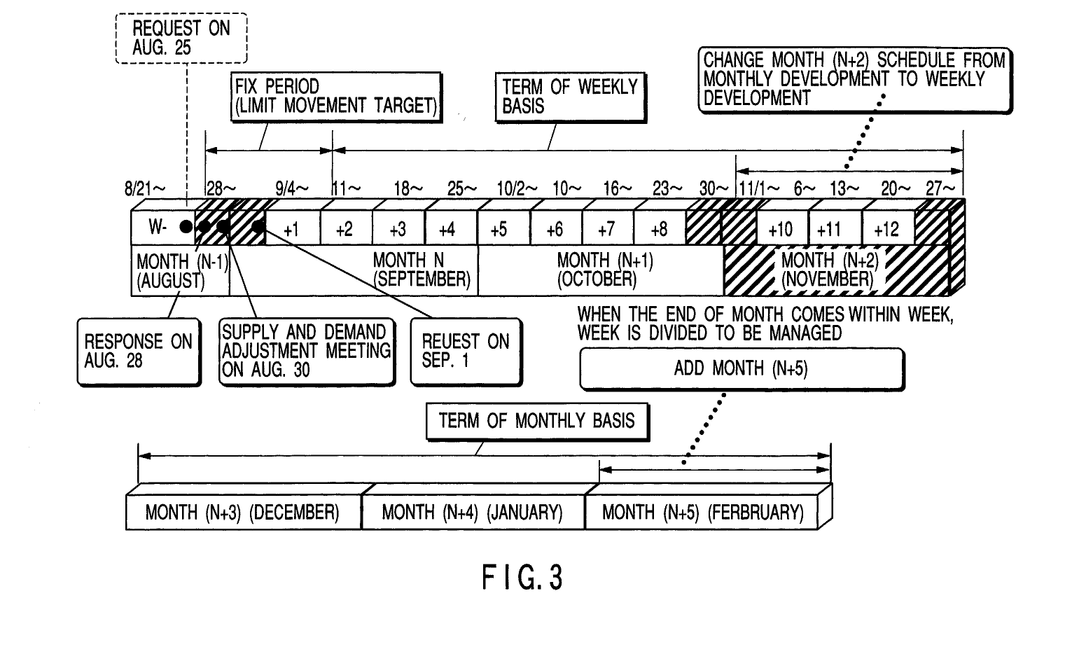

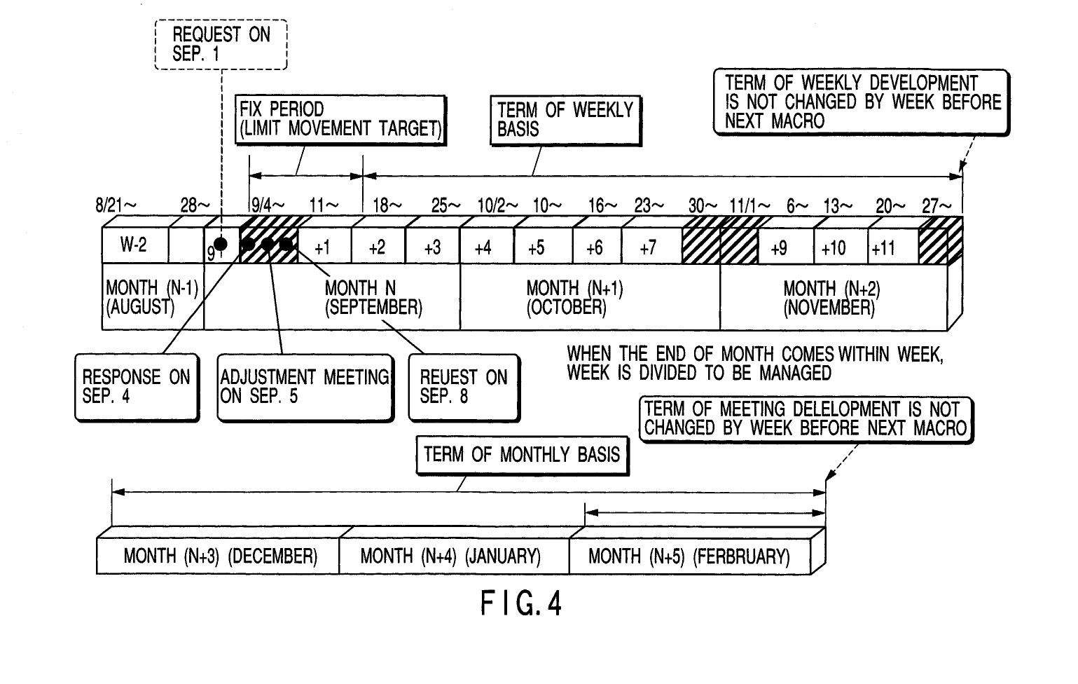

FIG. 3 schematically shows the manufacturing schedule of the last week of the month and FIG. 4 schematically shows the manufacturing schedules of the next and subsequent weeks. The manufacturing schedules of six months are formed. Since the schedules are fundamentally managed on a calendar monthly basis, a term of one week is deleted from the schedule every month. The term for the manufacturing schedules (both of monthly and weekly schedules) is extended when the request is received on each predetermined day before the last week every month. For example, when it is assumed that August 30 is a day on which the supply and demand adjustment meeting is held, the monthly manufacturing schedule of the month (N+2) (November) is developed to the weekly schedule (the term for the weekly schedule is extended by one month) at the request time on August 25 to add the last month (N+5) (February) in the scheduled term (the term for the monthly schedules is extended by one month). In case where the end of the month comes within a week, the present week is divided into two portions to be managed by the respective months. Accordingly, at the beginning of the month, the factory is notified of the weekly manufacturing schedules of 13 weeks at the maximum and the monthly manufacturing schedules of three months subsequent to the above as shown in FIG. 3. As shown in FIG. 4, in the next week, the factory is notified of the weekly manufacturing schedules of 12 weeks and the monthly manufacturing schedules of three months. At the end of the month, the factory is notified of the weekly manufacturing schedules of 9 weeks and the monthly manufacturing schedules of three months.

The manufacturing schedules are reviewed every week. However, in some cases, it is not preferable to review the schedules of the whole weeks. For example, in the above description, the next week schedule can be changed on a predetermined day of the previous week. However, as to the number of products to be manufactured in the next week, the delivery time has been shown in response to the order entry in many cases and the preparations of the line have been made in many cases. Accordingly, the schedule of the next week and that of the subsequent week are executed as they have been determined at the request time. The schedules are not changed. That is, the weekly schedules determined two weeks ago are not changed. Accordingly, when the request is received, the fluctuation of demand is adjusted in the schedules of the third week and after. Consequently, the factory can arrange the parts, the intermediate products, and the operators of two weeks on the basis of the manufacturing schedules notified every week. The procurement of the parts, the intermediate products, and the operators can be freely made. The manufacturing line of the factory can be efficiently operated. The weeks during which the manufacturing schedules are not changed are not limited to the two weeks of the next and subsequent weeks. The next week alone can be set. Alternatively, three weeks or more can also be set.

The concept of the limit of the number of products used in the production management of the present production system will now be described.

The weekly manufacturing schedule (hereinbelow, referred to as a weekly MPSI) denotes the number of products to be manufactured for each sales route and for each week desired by the business department. A weekly demand forecast response (weekly C-PSI response) denotes the number of products which can be manufactured (the number of order-acceptable products) for each sales route and for each week returned from the factory to the business department. The number is equivalent to the total amount for the routes per month. The weekly C-PSI response is formed on the basis of the amount per week every marketing model (factory completion basis). Since the weekly manufacturing schedules of 13 weeks at the maximum are notified, the responses of 13 weeks at the maximum are formed in accordance with the above schedules. The amount to be remained because there is no order entry is “reduced” in principle, so that the right to accept the order disappears. However, the amount is adjusted in the next week and after.

A manufacture-possible limit denotes the amount of products which can be manufactured at the present time every week. The limit is formed on a marketing model basis (factory completion basis). The limit is equivalent to the amount obtained by the daily manufacturing schedule (production start basis).

A planning limit denotes the number of products as a remainder obtained by subtracting the manufacture-possible limit from the weekly C-PSI response.

The above-mentioned limits are determined on the basis of the following rule.

The weekly MPSI denotes the number of products in the response from the factory in a week W (present week) to determine the amount (limit) for each route of a week (W+1). A request is formed on a predetermined day in a week (W−1) and a response commitment is returned from the factory on the predetermined day in the week W. The final adjustment can be made after the arrival of the response but before the request transmission date. As mentioned above, however, the limits of the weeks W and (W+1) are fixed, and the limits of a week (W+2) and the subsequent weeks can be varied. After the reception of the response on the predetermined day in the week W, the term up to the week (W+2) is set to a limit movement target (in this term, changing is impossible). The weekly MPSI is formed on a sales (=shipment) basis every marketing model. When it is assumed that it is a month N at the present, the manufacturing schedules are developed on a weekly basis by a month (N+2). After a month (N+3), the schedules are developed on a monthly basis (in the inside affairs, on a weekly basis). As mentioned above, when the end of the month comes within the week, the present week is divided into two portions to be managed in the respective months. Accordingly, two limits exist.

As for the weekly C-PSI response, the number of products in the response from the factory in the week W is automatically allocated to determine the amount (limit) for each route of each of the week (W+1) and the subsequent weeks. After the response reception on the predetermined day in the week W, the term up to the week (W+2) is set as a limit movement target. The weekly C-PSI response matches the weekly amount of each of the manufacture-possible limit and the planning limit. The weekly limit before the week W is deleted when the production of the week W is completed. The deleted limit is temporarily shifted to a (new) deleted limit of the week (W+1) and, after that, it is adjusted by a limit movement application. The response is formed every marketing model.

As for the manufacture-possible limit, the amount (limit) for each route of the week (W+1) is determined by a blanket manufacture instruction in the week W. The manufacture-possible limit has an interlocking relation with the amount of the weekly C-PSI response. The weekly limit before the week W is deleted.

The planning limit has an interlocking relation with the weekly MPSI and the weekly C-PSI response. A response from the factory is formed on the predetermined day in the week W, the number of products in the response is automatically allocated among the routes, and after that, the limit of the week (W+1) is advanced to the manufacture-possible limit. The planning limit is deleted.

The daily manufacturing schedule is equivalent to the manufacture-possible limit.

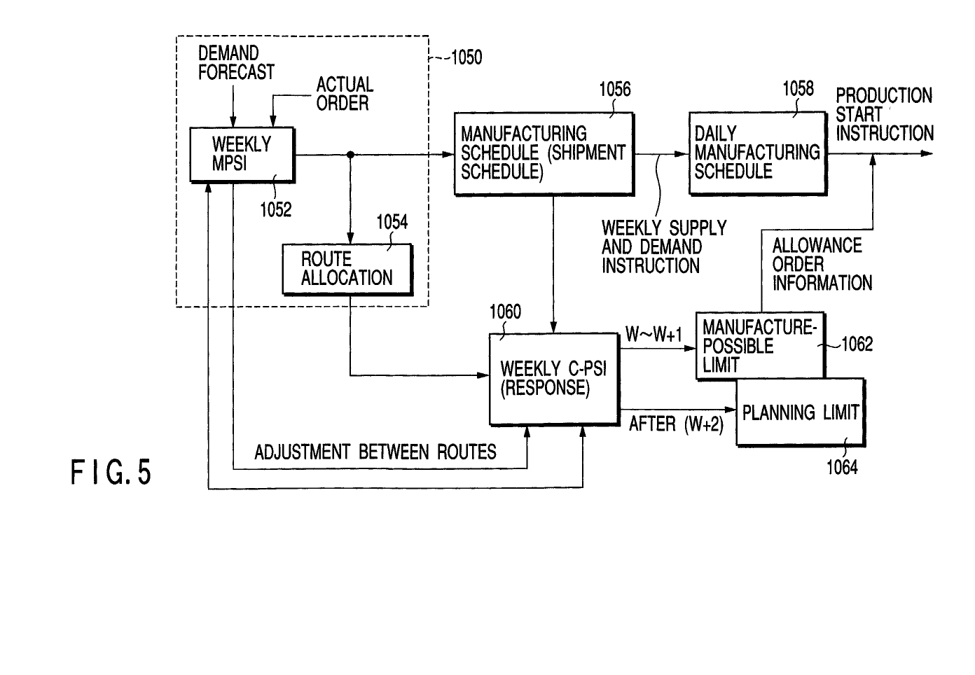

FIG. 5 schematically shows the relation between the above-mentioned limits. The weekly MPSI 1052 and the route allocation 1054 surrounded by a broken line 1050 are included in a business department system and the others are included in a manufacturing department system. The weekly MPSI 1052 is formed in accordance with the demand forecast, the weekly shipment schedule 1056 is formed in accordance with the demand forecast, and further, the daily manufacturing schedule 1058 is formed in accordance with the shipment schedule 1056. In response to the weekly shipment schedule 1056, the manufacturing department system returns the weekly C-PSI response 1060 as a schedule regarding the number of products, which can be manufactured in the factory, to the business department system. When the number of products in the response is smaller than the number of products scheduled, the products are allocated among the sales routes. As to the weekly C-PSI response, the weekly C-PSI response of the present week W and that of the next week (W+1) are included in the manufacture-possible limit 1062. Orders corresponding to the number of products as the above limit can be received (alternatively, the delivery time can be guaranteed). Since the weekly C-PSI responses of the week (W+2) and the subsequent weeks are included in the planning limit 1064, a variation may occur. When the actual orders received by the business department system are sent to the manufacturing department system, the orders as allowance order information causes an instruction to start the production as much as the number of products ordered within the manufacture-possible limit. As to products other than the targets of the supply and demand adjustment meeting, an instruction thereof is generated from the manufacturing schedule (shipment schedule) to the weekly C-PSI response.

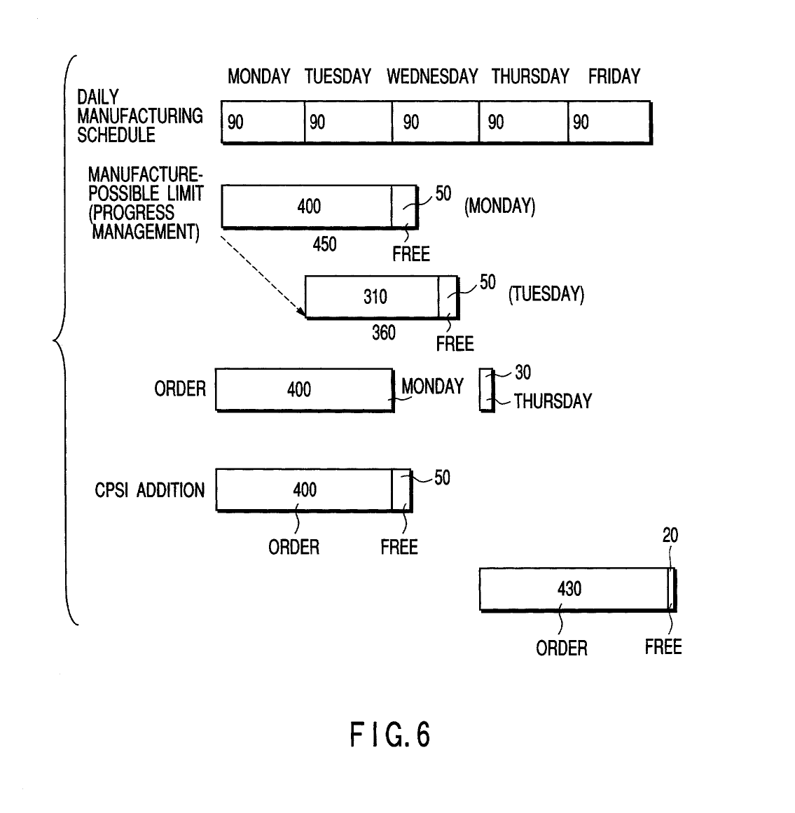

FIG. 6 is a diagram showing the relation between the daily manufacturing schedule and the manufacture-possible limit when 90 products are manufactured every day.

It is assumed that the actual orders (actual orders) correspond to 400 products on Monday and correspond to 30 products on Thursday. The manufacture-possible limit (indicating how many products can be manufactured in this week) on Monday includes 450 products. Since the actual orders correspond to 400 products, 50 products are free. On Tuesday, the manufacture-possible limit is reduced to 360 products but 50 products are free as ever. CPSI addition (to manage an accumulated (added) situation of the actual orders) denotes 400 products (50 products are free) on Monday and it denotes 430 products (20 products are free).

The control of limit allowance will now be described. The limit allowance is performed every route and every model. An allowance-waiting order is determined by an expression of {finished date [(desired delivery time)−(delivery lead time)]+(entry order)}. The C-PSI limit is first allowanced. The manufacture-possible limit and the planning limit of the same week as that having the allowanced C-PSI limit are allowanced. The manufacture-possible limit and the planning limit of the same week as that having the finished date are allowanced.

The planning limits and the allowance-order waiting orders of the respective manufacture-possible limits can be changed.

The head office informs the factory of the request (the number of products desired) for each route in the week (W−1). The limits of the weeks W and (W+1) are fundamentally determined. When the deleted limit exists in the week W, the adjustment is made to apply the limit movement.

The factory makes a response about the number of products, which can be manufactured, to the head office in the week W (next week). When the number of products desired is equivalent to the number of products responded, the manufacturing schedules from the week (W+2) to the last week of the month (N+2) (the schedules of the weeks W and (W+1) are already determined) are immediately determined.

When the number of products requested is not equivalent to the number of products responded, the head office adjusts the amount for each route to determine the amount. When the number of products responded is smaller than the number of products requested, the amount is allocated among the respective routes and, after that, the weekly manufacturing planning limit, the C-PSI response limit, the manufacture-possible limit, and the planning limit are immediately formed. The amount of the week (W+1) included in the deleted limit is adjusted due to the limit movement. The subsequent amounts are included into the requested amount and the resultant is transmitted. Since the number of products responded denotes the total amount for each model, the amount is automatically allocated among the routes. The automatic allocation is performed as follows.

(1) present limit priority [the present limit and the amount with a small number of requests are prioritized (kept)]

(2) keeping 10 products or less

(3) allocation for increased route

When the total amount of (1)>the number of products in the response, the total amount of (2)>the number of remaining products in the response, or the total amount of (3)>the number of remaining products in the response, proportional allocation is performed.

Procedure of automatic allocation

A=selecting the smaller one between the present limit and the number of products in this request

B=selecting the amount less than 10 products (when the amount is selected in A, a difference between 10 products and the selected amount is set to an amount to be selected)

C=the amount of [(the number of products in this request)−A−B]

Values of the above A to C are obtained every model and every route. The next table shows an example of the automatic allocation result.

| | Previous | | Allocation | Allocation | Allocation |
|---|---|---|---|---|---|
| | response | | ref. A | ref. B (10 | ref. C |
| | (present | This | (smaller | (products or | (increased |
| Route | limit) | request | amount) | less) | amount |
| A | 0 | 10 | 0 | 10 | 0 |
| B | 5 | 10 | 5 | 5 | 0 |
| C | 100 | 100 | 100 | 0 | 0 |
| D | 70 | 100 | 70 | 0 | 30 |
| E | 120 | 100 | 100 | 0 | 0 |
| Total | 295 | 320 | 275 | 15 | 30 |

Allocation will be made with respect to allocation reference A.

When the total reference value of A>the amount in the response, the proportional allocation is performed.

When the total reference value of A<the amount in the response, a difference therebetween is used as the later processing.

When the reference value of A=0, the entire amount is set to the deleted limit.

Allocation will be made with respect to allocation reference B.

When the total reference value of B>the remaining amount in the response, the proportional allocation is performed.

When the total reference value of B<the remaining amount in the response, a difference therebetween is used as the later processing.

When the reference value of B=0, the entire amount is set to the deleted limit.

Allocation will be made with respect to allocation reference C. When the total reference value of C>the remaining amount in the response, the proportional allocation is performed.

When the total reference value of C<the remaining amount in the response, a difference therebetween is set to the deleted limit.

When the reference value of C=0, the entire amount is set to the deleted limit.

When the proportional allocation is performed and a fraction (the remainder of division) is derived, the fraction is set to the deleted limit.

The entire system according to the embodiment constituted as mentioned above will now be described.

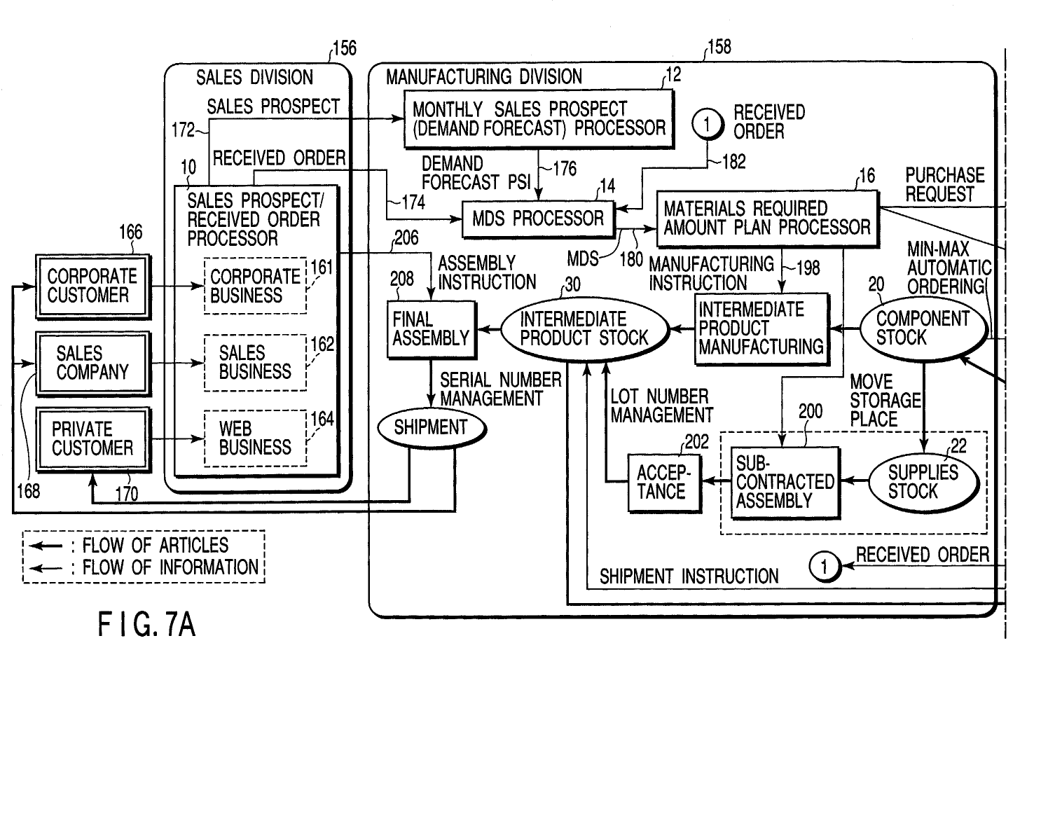

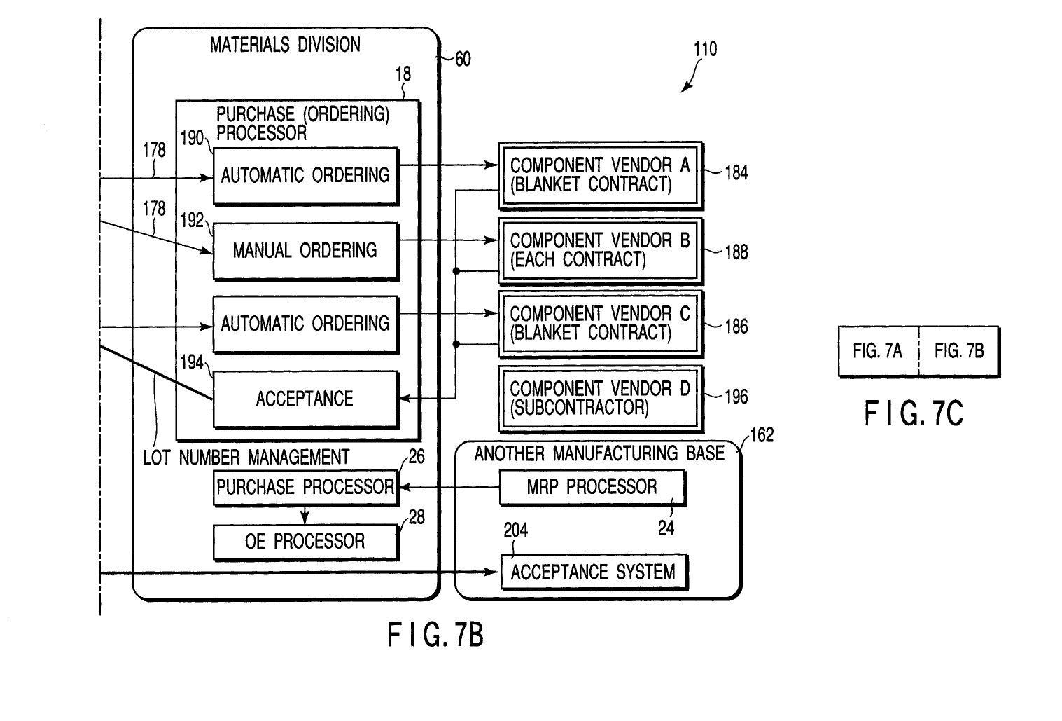

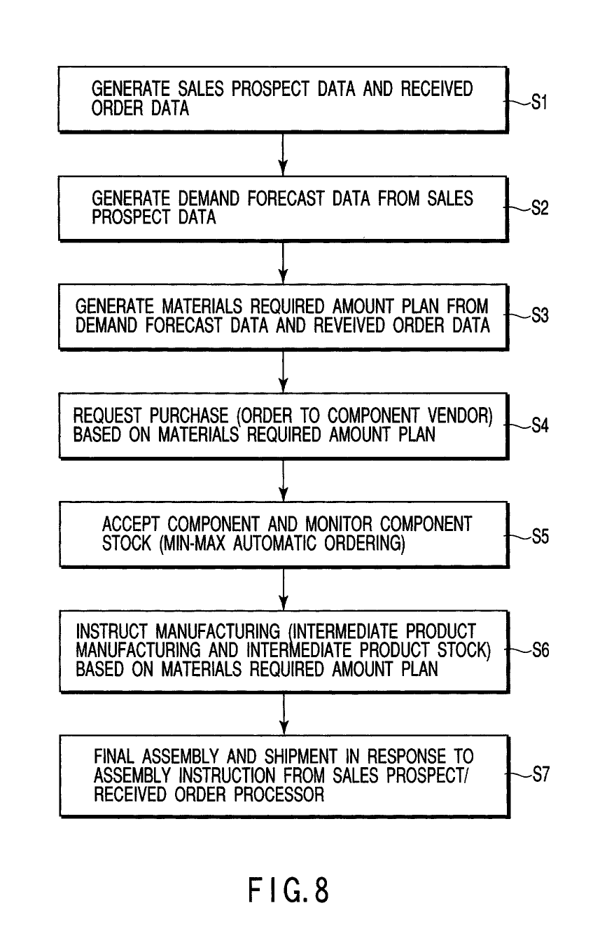

FIGS. 7A-7C are a block diagram showing the entire constitution of the order assembly production system. FIG. 8 is a flowchart showing the operation. The present system includes the business department, the manufacturing department, a material department, and a sub system in another manufacturing location. Another manufacturing location is a manufacturing section in a location other than the location for the manufacturing department of the same company.

The present system comprises sub systems such as a sales division 156, a manufacturing division 158, a materials division 160, and another manufacturing base 162. Examples of another manufacturing base 162 include a manufacturing department of the same company located in a place other than the manufacturing division 158.

The sales division 156 has a sales prospect/received order processor 10, receives corporate business data 161, sales business data 162, and Web business data 164 from a corporate customer 166, a sales company 168, and private customer 170, respectively, and obtains sales prospect data 172 and received order data 174 (step S1).

The manufacturing division 158 includes a monthly sales prospect (demand forecast) processor 12, an MDS (master demand schedule) processor 14, and a material required amount plan processor 16. The monthly sales prospect processor 12 obtains a monthly sales prospect (demand forecast PSI (products-sales-inventory) for demand adjustment of the products and components) from a sales prospect 172 (step S2). The MDS processor 14 obtains a master demand schedule (MDS) (so-called production plan) from demand forecast data 176 and received order data 174 (step S3). The material required amount plan processor 16 obtains purchase request data 178 from MDS data 180 and received order data 182 from the materials division 160.

The material required amount plan processor 16 transfers the purchase request data 178 to a purchasing (ordering) processor 18 of the materials division 160, and sends the order to a component vender A 184 or C 186 (blanket contract), or a component vender B 188 (each contract) by an automatic ordering system 190 or a manual ordering system 192 (step S4). After the components delivered from the component vender (184, 186, 188) are accepted by an acceptance system 194, the components are stored as the component stock in a component warehouse 20 of the manufacturing division 158. The component warehouse 20 also manages a lot number.

The components in the component warehouse 20 are also moved to a warehouse 22 of a component vender D 196 (subcontractor), and stored as a supplies stock. The warehouse 22 of the component vender D 196 is physically in a company of the component vender D 196, and is outside the manufacturing division 158 of the company, but is regarded as being in the manufacturing division 158 for the sake of management of the system. On the other hand, the component warehouse 20 constantly monitors a warehousing amount and discharge amount, and updates a stock amount. When the stock amount is less than a defined amount, an order is automatically sent to the component vender 184, 188 (blanket contract) via the automatic ordering system 190 of the materials division 160 in order to obtain the defined amount (Min-Max automatic ordering: step S5).

Material requirements planning (MRP) data from an MRP processor 24 (a system for arranging a master production plan by component development of a product constitution, and optimizing/managing a flow of articles for forming the finished product from material on a time base) in another manufacturing base 162 is supplied to an order entry (OE) processor 28 via a purchase processor 26 of the materials division 160. The OE processor 28 supplies received order data 182 to the MDS processor 14.

The components in the component warehouse 20 are discharged from the warehouse based on manufacturing instruction data 198 from the material required amount plan processor 16, and the intermediate products are manufactured, transferred to an intermediate product warehouse 30, and result in the intermediate product stock (step S6).

The components in the supplies warehouse 22 are also discharged from the warehouse based on the manufacturing instruction data 198 from the material required amount plan processor 16, subcontracted assembly 200 by the component vender D 196 is performed, and the intermediate products are manufactured. The intermediate products obtained by the subcontracted assembly 200 are delivered into the intermediate product warehouse 30 via an acceptance system 202. The intermediate product warehouse 30 also manages the lot number. Moreover, the intermediate products in the intermediate product warehouse 30 are also sent to an acceptance system 204 of another manufacturing base 162.

The components in the intermediate product warehouse 30 are discharged from the warehouse 30 based on assembly instruction data 206 from the sales prospect/received order processor 10, and the final assembly 208 is performed (step S7). Serial numbers of the finished products are managed, and the finished products are shipped to the private customer 170, corporate customer 166, and sales company 168.

According to the assembly-to-order production system 110, the components are purchased based on the demand forecast 176, and the intermediate products are manufactured, and held as the stock, so that the finished products can directly be shipped in response to an assembly instruction 206 based on the order 174 received from the sales division 156. Further, the ordering of the components and the manufacturing of the intermediate products from the components, are based on the demand forecast 176, and there is little fear of an increase of the stock inventory of the intermediate products. Moreover, even if the stock inventory of the intermediate products increases due to fluctuation of demand for the product, the intermediate products are designed to be general purpose, and can be diverted to other products. Therefore, the negative effects of demand fluctuation are minimized.

In the assembly-to-order production system 110, a certain amount of intermediate product stock must always be available, and a degree of stability in the procurement of components is important. A vender managed inventory system for procurement of components will next be described.

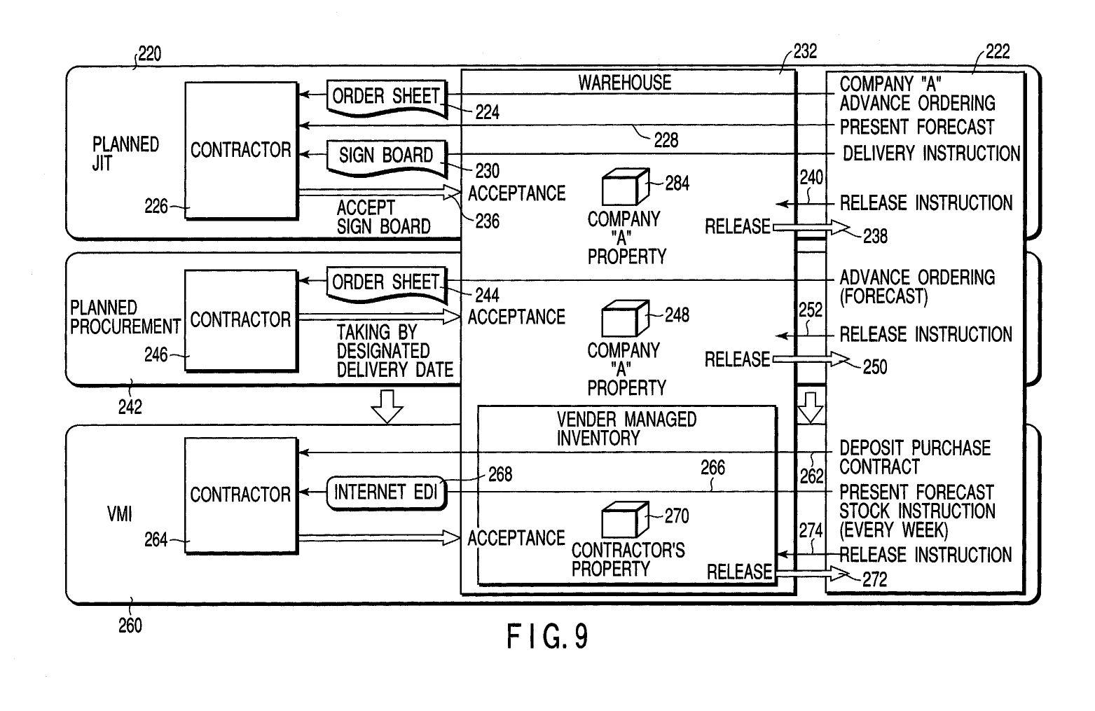

FIG. 9 shows, for comparison, a planned just-in-time (JIT) system 220 (the components are delivered while a component delivery date is adapted for a necessary time in accordance with a production process), a planned procurement system 242, and vender managed inventory (VMI) system 260. Here, the components include not only simple components but also intermediate products subjected to manufacturing.

In the planned JIT system 220, company “A” 222 (manufacturer) as an orderer issues an order sheet 224 to a contractor 226 (component vender 226) in advance, and a future manufacturing plan is forecast 228. The contractor 226 starts component delivery preparation (manufacturing) according to the forecast 228. When the components are required, the company “A” 222 sends a delivery instruction 230 to the component vender 226. The component vender 226 delivers the components into the component warehouse 232. The company “A” 222 brings the components into a company's property 234 when the components are accepted 236 (just in time). Thereafter, the components are released 238 from the component warehouse 232 in accordance with a release instruction 240.

In the planned procurement system 242, the company “A” 222 sends the order sheet 244 to the contractor 246 (component vender 246) in advance, and forecasts a future manufacturing plan. In the planned JIT system 220, the components are delivered in response to the delivery instruction 230. However, in the planned procurement system 242, a delivery date is designated at the time of the advance ordering, and the component vender 246 delivers the components into the warehouse 232 by the delivery date designated in the order sheet 244. Also in this case, the company “A”222 brings the components into the company's property 248 when the components are received. Thereafter, the components are released 250 to the company “A” 222 from the warehouse 232 in accordance with the release instruction 252.

In contrast, in the vender managed inventory (VMI) system 260 (the components remaining in a contractor's ownership are deposited/stocked in the factory warehouse, and payment is made for the components discharged from the factory and used in production), first the company “A” 222 concludes a deposit purchase contract 262 with the contractor 264. Subsequently, the company “A” 222 forecasts a future manufacturing plan to the contractor 264, and presents to the contractor 264, every week, a stock instruction 266 (the required number of components) for the following week. The forecast and stock instruction 266 are presented via an Internet electronic data interchange (EDI) system 268 (a system in which transaction data (SLIP format) between the companies is interchanged according to a domestic or standard format). As described above, since the contractor 264 is also informed of a stock situation, the contractor 264 starts the manufacturing of the components based on the forecast, and delivers a designated quantity of components into the component warehouse 232 by a date designated in the stock instruction 266.

Additionally, when the components are delivered into the warehouse 232, the ownership is not transferred, and the components still remain the contractor's property 270. Thereafter, the components discharged from the component warehouse 232 are used in the component assembly, the intermediate products are manufactured, and the intermediate product stock results. The intermediate product stock is also left in the contractor's property 270 without transferring the ownership. Thereafter, the intermediate products are released 272 to the company “A” 222 in response to the release instruction 274, and the ownership of the intermediate products shifts to the company “A” 222 for the first time at the release 272 (the payment is made to the vender).

Both the orderer (for example, company “A” 222) and the component vender (for example, contractor 264) obtain advantages from the VMI system 260 described in relation to FIG. 9. For example, one advantage to the orderer from the VMI system 260 is that the components and intermediate product stock in the warehouse are the contractor's property, and the amount of stock inventory owned by the orderer is consequently reduced. Another advantage to the orderer is that the required amount of stock is more easily obtained (i.e., improved stability of stock procurement).

One advantage for the component vender from the VMI system 260 is that the production plan is stabilized by the forecast (once per month in the conventional system, but once per week in the VMI system 260). As a further advantage to the component vender from the VMI system 260 compared to the planned JIT system 220, stock transportation timing is easily controlled, and the stock situation can be updated.

As described above, since the weekly manufacturing schedules are formed between the business department and the manufacturing department, the response based on a weekly basis is made in response to the inquiry about the delivery time from the customer, so that the precision of the response is higher than the conventional delivery time on a monthly basis. The manufacturing schedules are reviewed every week. Since the schedules of the next and subsequent weeks are deleted from the target to be reviewed, the fluctuation of balance of supply and demand can be immediately adjusted. Since the number of products manufactured in this two weeks is guaranteed, the delivery time can be confirmed before actual order entry, so that too much order entries, in which delivery time cannot be kept, can be prevented. Furthermore, there is provided the order assembly production system wherein the part vender forms forecast data indicative of delivery time and the amount, when and which the vender managed inventory should be provided, the forecast data is submitted to the part vender prior to an inventory instruction by a predetermined period, the forecast data is corrected in consideration of fluctuation factors, the inventory instruction is formed, the inventory instruction is submitted to the part vender prior to a shipment instruction by a predetermined period, the inventory is deposited, and in response to order entry, the shipment instruction is submitted to the part vender to deliver the vender managed inventory. As mentioned above, intermediate products are held as an inventory, so that the system can deal with the fluctuation of demand without extending lead time from the order entry to the delivery. The vender managed inventory (usage of the inventory as business connection's assets) system contributes to the reduction in part stocktaking assets, the provision of the necessary amount of parts, and the stabilized acquisition on the manufacturer side. When the order assembly production system is combined with the vender managed inventory system to forecast the manufacturing schedules, the vender also has advantages in that the production schedules for part manufacture and the delivery schedules can be stabilized.

According to the present embodiment, there is provided an order assembly production method including the steps of: forming manufacturing schedules of several months on the basis of a demand forecast on a predetermined period basis that is shorter than a monthly basis, reviewing the manufacturing schedules every predetermined period, and then instructing the reviewed manufacturing schedules of several months; procuring parts on the basis of the instructed manufacturing schedules; issuing a manufacture instruction when an order is received from a customer; and assembling the parts in accordance with the manufacture instruction.

According to the present embodiment, there is provided an order assembly production method including the steps of: forming manufacturing schedules of several months on the basis of a demand forecast on a predetermined period basis that is shorter than a monthly basis, when the manufacturing schedules are reviewed every predetermined period, excepting a manufacturing schedule of a predetermined period from a target to be reviewed, and then instructing the reviewed manufacturing schedules of several months; calculating the number of order-acceptable products for each predetermined period excepted from the reviewed target and the scheduled number of products for each subsequent predetermined period on the basis of the instructed manufacturing schedules; and making a response about delivery time to a customer with reference to the calculated number of order-acceptable products.

According to the present embodiment, there is provided an order assembly production system comprising: a first system which forms manufacturing schedules of several months on the basis of a demand forecast on a predetermined period basis that is shorter than a monthly basis and then reviews the manufacturing schedules every predetermined period; and a second system which procures parts on the basis of the manufacturing schedules of several months provided by the first system and, when receiving an assembly instruction from the first system in accordance with an order from a customer, instructs to start to assemble the parts.

According to the present embodiment, there is provided an order assembly production system comprising: a first system which forms manufacturing schedules of several months on the basis of a demand forecast on a predetermined period basis that is shorter than a monthly basis, when the manufacturing schedules are reviewed every predetermined period, excepts a manufacturing schedule of a predetermined period from a target to be reviewed, and then reviews the manufacturing schedules; and a second system which procures parts on the basis of the manufacturing schedules of several months provided from the first system and also makes a response about the number of order-acceptable products for each predetermined period excepted from the reviewed target and the scheduled number of products to be manufactured for each subsequent predetermined period to the first system, wherein the first system makes a response about delivery time to a customer with reference to the number of order-acceptable products.

According to the present embodiment, since the manufacturing schedules on a period basis that is shorter than a monthly basis are formed in the business department and the manufacturing department, a substantially correct response can be made in response to an inquiry about delivery time from a customer. As mentioned above, since delivery time can be known before order entry, too much order entries, in which delivery time cannot be kept, can be prevented.

Since the manufacturing schedules are reviewed on a period basis that is shorter than a monthly basis, the fluctuation in balance between supply and demand can be adjusted.

Moreover, since a plurality of manufacturing schedules near the present time are excepted from the reviewed target and the number of order-acceptable products is guaranteed, the precision of delivery time for the term of the schedules is raised.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all change that come within the meaning and range of equivalency of the claims are therefore intended to be embraced therein. For example, the product as a manufactured target according to the present system is not limited to an electronic product such as a personal computer but the present system can be applied to various kinds of products.

Moreover, the present invention can also be implemented as a computer readable recording medium in which a program for allowing a computer to execute predetermined means, allowing the computer to function as predetermined means, or allowing the computer to realize a predetermined function is recorded.

What is claimed is:

1. An order assembly production method comprising:
preparing manufacturing schedules of several months on the basis of a demand forecast on a predetermined period basis that is shorter than a monthly basis, reviewing the manufacturing schedules every predetermined period, and issuing the reviewed manufacturing schedules of several months;
issuing a procurement instruction of parts on the basis of the reviewed manufacturing schedules;
issuing a manufacture instruction when an order is received from a customer; and
assembling the parts in accordance with the manufacture instruction.

2. The method according to claim 1, wherein the number of days of the predetermined period basis that is shorter than the monthly basis is arbitrarily set.

3. The method according to claim 1, wherein the reviewed manufacturing schedules and the manufacture instruction are issued by a business department system and the procurement instruction of parts is issued by a manufacturing department system.

4. The method according to claim 3, wherein when the reviewed manufacturing schedules issued from the business department system is not realized, the manufacturing department system returns the fact to the business department system to request to further change the reviewed manufacturing schedules.

5. The method according to claim 3, wherein the manufacturing department system presents delivery time information for each predetermined period basis to the business department system.

6. The method according to claim 3, wherein the manufacturing department system presents delivery time information for each sales route, for each product model, and for each predetermined period basis to the business department system.

7. The method according to claim 3, wherein the manufacturing department system deposits the procured parts as a vender managed inventory.

8. The method according to claim 7, wherein said vender managed inventory includes a general-purpose intermediate product which can be used in common to a plurality of products.

9. An order assembly production method comprising:
preparing manufacturing schedules of several months on the basis of a demand forecast on a predetermined period basis that is shorter than a monthly basis, reviewing the manufacturing schedules every predetermined period while excepting a manufacturing schedule of a predetermined period from a target to be reviewed, and issuing the reviewed manufacturing schedules of several months;
calculating the number of order-acceptable products for each predetermined period excepted from the reviewed target and the scheduled number of products to be manufactured for each subsequent predetermined period on the basis of the reviewed manufacturing schedules; and
making a response about delivery time to a customer with reference to the calculated number of order-acceptable products.

10. The method according to claim 9, wherein the number of days of the predetermined period basis that is shorter than the monthly basis is arbitrarily set.

11. The method according to claim 9, wherein the reviewed manufacturing schedules are issued by a business department system and the number of order-acceptable products and the scheduled number of products are calculated by a manufacturing department system.

12. The method according to claim 11, wherein when the reviewed manufacturing schedules issued from the business department system is not realized, the manufacturing department system returns the fact to the business department system to request to further change the reviewed manufacturing schedules.

13. The method according to claim 11, wherein the manufacturing department system presents delivery time information for each predetermined period basis to the business department system.

14. The method according to claim 11, wherein the manufacturing department system presents delivery time information for each sales route, for each product model, and for each predetermined period basis to the business department system.

15. The method according to claim 11, wherein the manufacturing department system deposits the procured parts as a vender managed inventory.

16. The method according to claim 15, wherein said vender managed inventory includes a general-purpose intermediate product which can be used in common to a plurality of products.

17. The method according to claim 11, wherein when the number of order-acceptable products is smaller than the number of products predetermined in the manufacturing schedule of the predetermined period, the business department system allocates the number of order-acceptable products between sales routs.

18. An order assembly production system comprising:
a first system which prepares manufacturing schedules of several months on the basis of a demand forecast on a predetermined period basis that is shorter than a monthly basis and reviews the manufacturing schedules every predetermined period; and
a second system which issues a procurement instruction of parts on the basis of the reviewed manufacturing schedules and, when receiving an assembly instruction from the first system in accordance with an order from a customer, instructs to start to assemble the parts.

19. The system according to claim 18, wherein the number of days of the predetermined period basis that is shorter than the monthly basis is arbitrarily set.

20. An order assembly production system comprising:
a first system which prepares manufacturing schedules of several months on the basis of a demand forecast on a predetermined period basis that is shorter than a monthly basis and reviews the manufacturing schedules every predetermined period while excepting a manufacturing schedule of a predetermined period from a target to be reviewed; and
a second system which issues a procurement instruction of parts on the basis of the reviewed manufacturing schedules and makes a response about the number of order-acceptable products for each predetermined period excepted from the reviewed target and the scheduled number of products to be manufactured for each subsequent predetermined period on the basis of the reviewed manufacturing schedules to the first system,
wherein the first system makes a response about delivery time to a customer with reference to the number of order-acceptable products.

21. The system according to claim 20, wherein the number of days of the predetermined period basis that is shorter than the monthly basis is arbitrarily set.
